(19) United States
(12) Patent Application Publication
(10) Pub. No.: US 2013/0233964 A1
(43) Pub. Date: Sep. 12, 2013

(54) TETHERED AERIAL SYSTEM FOR DATA GATHERING

(71) Applicants: Adam Woodworth, Melrose, MA (US); James Peverill, Canton, MA (US)

(72) Inventors: Adam Woodworth, Melrose, MA (US); James Peverill, Canton, MA (US)

(73) Assignee: AURORA FLIGHT SCIENCES CORPORATION, Manassas, VA (US)

(21) Appl. No.: 13/413,696

(22) Filed: Mar. 7, 2012

(51) Int. Cl. B64C 37/02; H02G 11/00; G05D 1/00; B64D 25/00; B64D 17/80

(52) U.S. Cl. 244/2; 244/139; 244/175; 191/12 R

(57) ABSTRACT

A tethered unmanned aerial vehicle (“UAV”) may be outfitted with a sensor payload for data gathering. The tethered UAV may be tethered to a ground station for constricting the flight space of the UAV while also providing the option for power delivery and/or bidirectional communications. The tethered UAV's flight path may be extended by introducing one or more secondary UAVs that cooperate to extend the horizontal flight path of a primary UAV. The ground station, which may be coupled with the tethered aerial vehicle, may comprise a listening switch configured to determine a condition of the tether such that the supply of power to the tether may be terminated when tether damage or a tether severance is detected.

### TECHNICAL FIELD

The present invention relates to systems and methods for use with a tethered Unmanned Aerial Vehicle (“UAV”). More specifically, the present invention relates to systems and methods for increasing safety and flight space of tethered UAVs.

### BACKGROUND INFORMATION

Tethering an aerial vehicle to a ground station is a proven method of restricting the flight space of that aerial vehicle. By restricting the flight space, the aerial vehicle can operate autonomously, or under human control, so that a fly-away will not occur. These tethered aerial vehicles may be outfitted with a suite of sensors for surveillance or other data gathering. In addition to restricting the flight space of an aerial vehicle, the tether may be used to deliver power and/or data communications to/from the aerial vehicle. Depending on the ground station power source, the aerial vehicle could stay aloft indefinitely, a highly desired attribute of any aerial vehicle.

An example of a tethered UAV is Israel Aerospace Industries' tethered hovering surveillance platform. The platform, designated Electric Tethered Observation Platform (“ETOP”), is a tethered unmanned hovering platform which can take off, hover in one place, and land without any additional landing and recovery systems. For additional information related to the ETOP, see, for example, the ETOP brochure, available at http://www.iai.co.il/sip_storage/FILES/7/38207.pdf.

A first disadvantage of existing tethered aerial vehicles is inherent to the tether itself, a limited flight space (i.e., no free flight). For instance, a tethered aerial vehicle user may wish to fly beyond the range that a single tethered aerial vehicle will allow.

A second disadvantage of existing tethered aerial vehicles is that, although they can reach higher vertical altitudes, their ability to expand the flight space horizontally can be greatly limited because of obstacles. For example, as an aerial vehicle travels horizontally, the tether may be obstructed by nearby landmarks. To overcome these disadvantages, it is necessary to design an aerial vehicle that is capable of freely traveling both vertically and horizontally. An aerial vehicle capable of freely traveling both vertically and horizontally would be valuable in urban environments where an aerial vehicle may be required to fly over or around structures (e.g., buildings). Similarly, the aerial vehicle should be able to clear overhead obstacles.

A third disadvantage of existing tethered aerial vehicles is the absence of emergency safety mechanisms and protocols designed to protect people and property on the ground from safety hazards. A first hazard and safety concern may be, for example, a falling aerial vehicle, which could harm any person or object below. A second hazard may be attributed to electrocution that can result from a severed high-voltage tether. For obvious reasons, exposure to a high-voltage conductor can lead to injury and death to any person with which it comes in contact.

Accordingly, the present application provides systems and methods for improving safety and extending the horizontal range and overall flight space of a tethered aerial vehicle.

### SUMMARY

The present disclosure endeavors to provide systems and methods for extending the horizontal range and overall flight space of a tethered aerial vehicle. The present disclosure also endeavors to provide systems and methods for increasing the safety of a tethered aerial vehicle.

According to a first aspect of the present invention, an aerial vehicle system for gathering data comprises: a ground station; a first aerial vehicle, wherein the first aerial vehicle comprises a sensor payload; a second aerial vehicle; a first tether portion operatively coupled between the ground station and the second aerial vehicle; and a second tether portion operatively coupled between the second aerial vehicle and the first aerial vehicle; wherein the first tether portion is configured to deliver power from the ground station to the second aerial vehicle and the second tether portion is configured to deliver power to the first aerial vehicle.

In certain aspects, the ground station, the first aerial vehicle and/or second aerial vehicle may comprise a device for adjusting the tension or length of the first tether portion.

In other aspects, the ground station may be coupled with a mobile platform or a stationary platform.

In certain aspects, the ground station may be further configured to deliver power from a power source to the first aerial vehicle or the second aerial vehicle.

In certain aspects, the ground station may comprise a listening switch configured to determine a condition of the first or second tether portions. The listening switch may cause the supply of power to the first or second tether portions to be terminated when tether damage or tether severance is detected.

According to a second aspect of the present invention, a safety system for use with a tethered aerial vehicle comprises: a ground station, wherein the ground station is configured to deliver power from a power source; a tether for coupling the aerial vehicle with the ground station, wherein the tether is configured to transmit power from the ground station to the aerial vehicle; a device positioned between the ground station and the aerial vehicle for adjusting the tension or length of the tether; and a listening switch, the listening switch being coupled with the ground station and positioned between the power source and the tether; wherein supply of power from the power source to the tether is terminated when the listening switch detects tether damage or tether severance.

According to a third aspect of the present invention, a safety method for use with a tethered aerial vehicle comprises the steps of: transmitting an electrical signal from a ground station to an aerial vehicle through a tether and back to the ground station via the same tether; listening for the electrical signal to be received back at the ground station; wherein the electrical signal received at the ground station is utilized as a received signal value; wherein the received signal value to set to zero or null when the electrical signal is not received at the ground station; comparing the received signal value to the transmitted electrical signal to determine a signal loss value; triggering the ground station to stop transmitting power through the tether when the received signal value is zero or null; instructing each aerial vehicle coupled to the tether to return to the ground station when the signal loss value has exceeded a predetermined signal loss threshold value; and authorize each aerial vehicle coupled to the tether to continue its current flight plan when the signal loss value has not exceeded the predetermined signal loss threshold value.

In certain aspects, each aerial vehicle coupled to the tether may enter safe-fall mode when the ground station stops transmitting power through the tether.

According to a fourth aspect of the present invention, an unmanned tethered aerial vehicle for increasing safety during descent comprises: a tether, wherein the tether is configured to couple with a ground station that is configured to supply power to the aerial vehicle; one or more propellers; a descent stabilization device for controlling the altitude of the aerial vehicle during descent; and a force-impact attenuator for reducing peak force during ground impact when power through the tether is no longer available.

In certain aspects, the descent stabilization device may comprise at least one of: (i) a parachute; (ii) stabilizing fins; or (iii) reaction wheel.

In certain aspects, the force-impact attenuator may be positioned on a leading porting of the aerial vehicle during descent such that the force attenuator is a first portion of the aerial vehicle to strike the ground first and attenuate the force of impact.

In certain aspects, the unmanned tethered aerial vehicle may comprise flight control surfaces configured to steer the unmanned tethered aerial vehicle during descent. The flight control surfaces may be actuated by power generated by the propulsion system auto-rotating during descent.

In certain aspects, the tether or tether portions of the various aspects may be further configured to communicate data.

### BRIEF DESCRIPTION OF THE DRAWINGS

These and other advantages of the present invention will be readily understood with reference to the following specifications and attached drawings, wherein:

FIG. 1a illustrates the top view of a primary tethered UAV;

FIG. 1b illustrates the bottom view of the primary tethered UAV;

FIG. 1c illustrates a frontal view of the primary tethered UAV;

FIG. 2a illustrates a side view of a tether;

FIG. 2b illustrates a cross sectional view of the tether;

FIGS. 3a and 3b illustrate a tethered UAV system according to a first aspect;

FIGS. 4a and 4b illustrate illustrates a tethered UAV system according to a second aspect;

FIG. 5 illustrates a tethered UAV system according to a third aspect;

FIG. 6 illustrates a tethered UAV system according to a fourth aspect;

FIG. 7a illustrates a block diagram for a ground station;

FIG. 7b illustrates a block diagram of the ground station couples with a primary UAV;

FIG. 8 illustrates a flowchart of a listening switch protocol.

FIG. 9a illustrates the top side of a safe-fall UAV;

FIG. 9b illustrates the bottom side of the safe-fall UAV;

FIG. 10a illustrates a system employing a safe-fall UAV; and

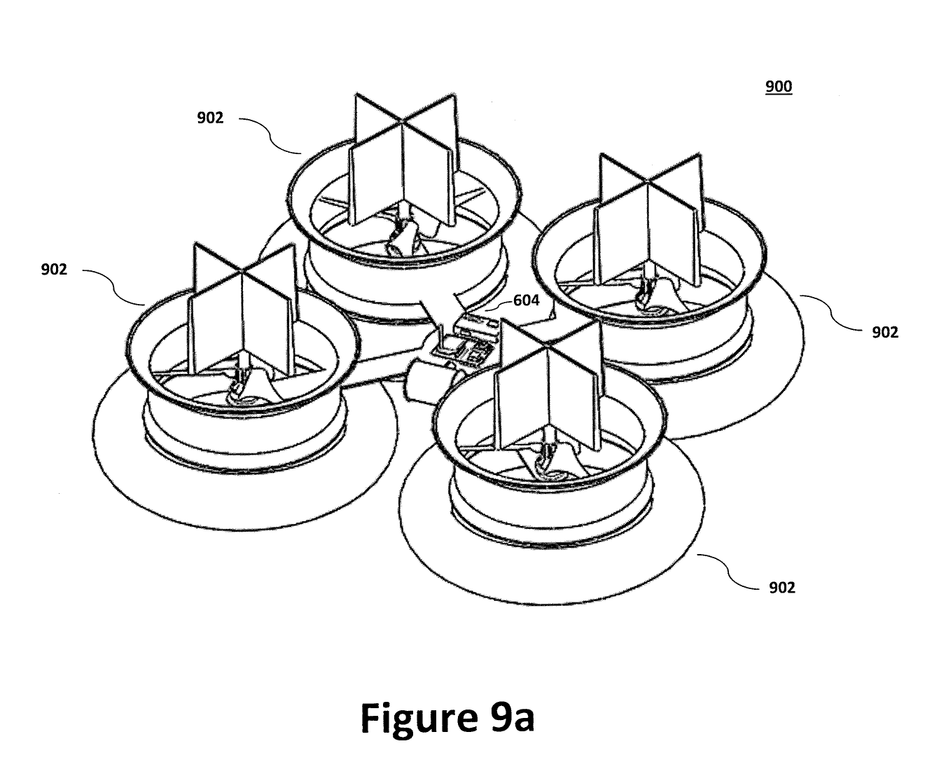

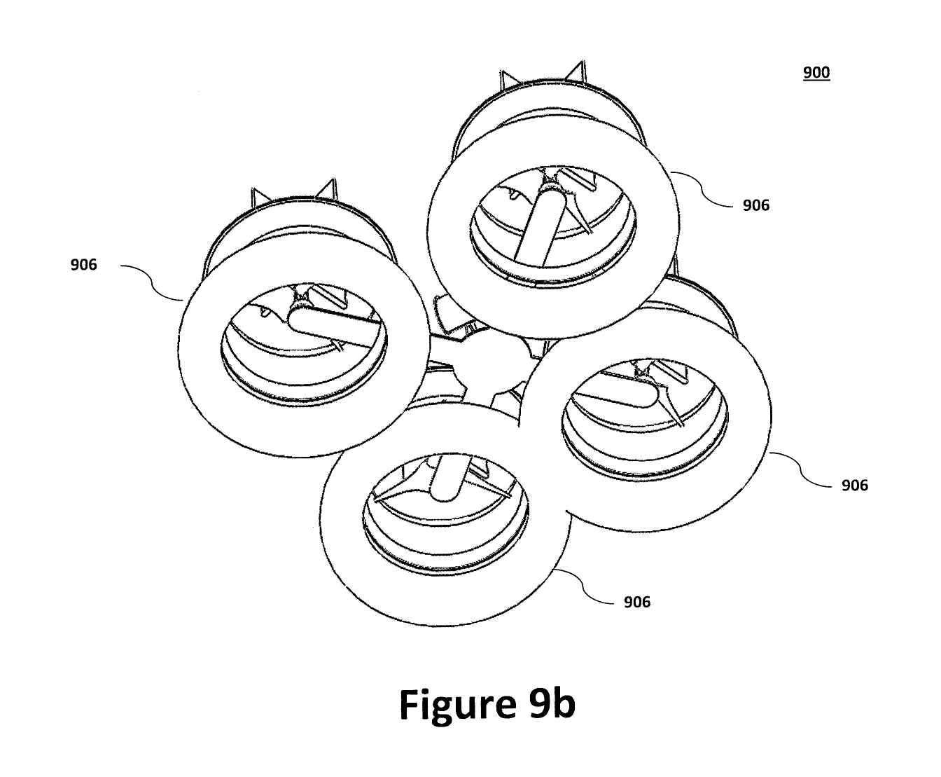

FIG. 9b illustrates a system employing a safe-fall UAV having active controls.

### DETAILED DESCRIPTION

Embodiments of the present invention will be described hereinbelow with reference to the accompanying drawings. In the following description, well-known functions or constructions are not described in detail because they would obscure the invention in unnecessary detail. For this application, the following terms and definitions shall apply:

The terms “communicate” and “communicating,” as used herein, refer to both transmitting, or otherwise conveying, data from a source to a destination and delivering data to a communications medium, system, channel, network, device, wire, cable, fiber, circuit, and/or link to be conveyed to a destination.

The term “computer,” as used herein, refers to a programmable device designed to sequentially and automatically carry out a sequence of arithmetic or logical operations, including without limitation, personal computers (e.g., those available from Gateway, Hewlett-Packard, IBM, Sony, Toshiba, Dell, Apple, Cisco, Sun, etc.), handheld processor-based devices, and any other electronic device equipped with a processor or microprocessor.

The term “database,” as used herein, refers to an organized body of data, regardless of the manner in which the data or the organized body thereof is represented. For example, the organized body of data may be stored to a data storage device in the form of one or more of a table, map, grid, packet, datagram, frame, file, e-mail, message, document, report, list, or in any other form.

The term “data storage,” as used herein, refers to one or more data storage devices, apparatus, programs, circuits, components, systems, subsystems, locations, and storage media serving to retain data, whether on a temporary or permanent basis, and to provide such retained data. The terms “storage” and “data storage” as used herein include, but are not limited to, hard disks, solid state drives, flash memory, DRAM, RAM, ROM, tape cartridges, and any other medium capable of storing computer-readable data.

The term “processor,” as used herein, refers to processing devices, apparatus, programs, circuits, components, systems and subsystems, whether implemented in hardware, tangibly embodied software or both, and whether or not programmable. The term “processor,” as used herein includes, but is not limited to, one or more computers, hardwired circuits, signal modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, and data processors.

The present disclosure endeavors to provide systems and methods for extending the horizontal range and overall flight space of a tethered aerial vehicle. In addition, the present application addresses the hazards and safety concerns of flying a tethered aerial vehicle in an urban environment. Existing aerial vehicles fail to address the above-mentioned limitations and safety hazards, whereas the various aspects of the present application provide valuable solutions. More specifically, the present application expands the capabilities of tethered aerial vehicles by overcoming these deficiencies, while also ensuring that nearby people and objects remain relatively safe.

Disclosed herein and described below is an improved tethered UAV and UAV system that may be outfitted with a suite of sensors for surveillance or data gathering (e.g., a sensor payload). During operation, the UAV may be tethered to a ground station that constricts the flight space of the UAV while also optionally providing power delivery and/or bidirectional communications between the ground station and one or more UAVs. The type of power delivered is preferably electric power, however other forms of power may be used. As will be discussed below, the ground station may be configured such that it may be mounted to either a stationary or mobile platform. Regardless of the type of platform, the ground station may be configured to generate power internally or to receive power from an external means.

The systems and methods of the present disclosure also recognize the desire to control the amount of tether deployed with regard to the distance between the ground station and the UAV or between two or more UAVs. For example, when there is too much tension (i.e., the tether is deployed too slowly), the UAV must overcome unnecessary force in order to stay aloft and/or maneuver. With too little tension (i.e., the tether is deployed too quickly), too much slack resides in the tether, and risks increase for snagging or entangling with objects in the vicinity. The currently disclosed systems employ a tether-management system that controls the tether tension by recognizing the total distance between the ground station and the UAV (or between multiple UAVs), and the rate at which this distance is changing. An ideal tension imparts minimal load on the aerial vehicles while minimizing the amount of slack in the tether.

The tether management device may reside on the ground station or on each UAV. Regardless of location, the tether-management device may comprise a spool and an electric motor (e.g., a stepper motor) for rotating the spool. A spring-ratchet mechanism may be used to control the winding/unwinding of the spool. As the spool is rotated, the tether may wrap around (shorten) or unwrap from (lengthen) the spool until a desired tether length is achieved. The desired tether length can be determined by measuring either the linear velocity or the position of the tether. The length of tether released could also be determined by measuring the rotational velocity or position of the spool. Rotational velocity and/or position of the spool measurements may be accomplished through a variety of means, including, for example, an optical sensor.

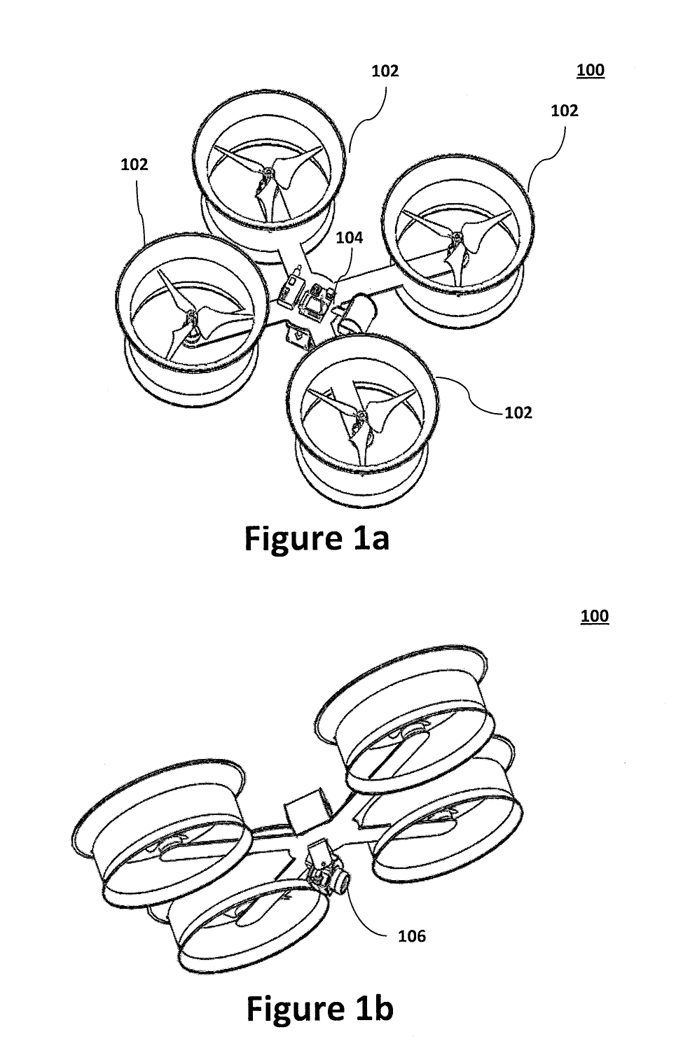

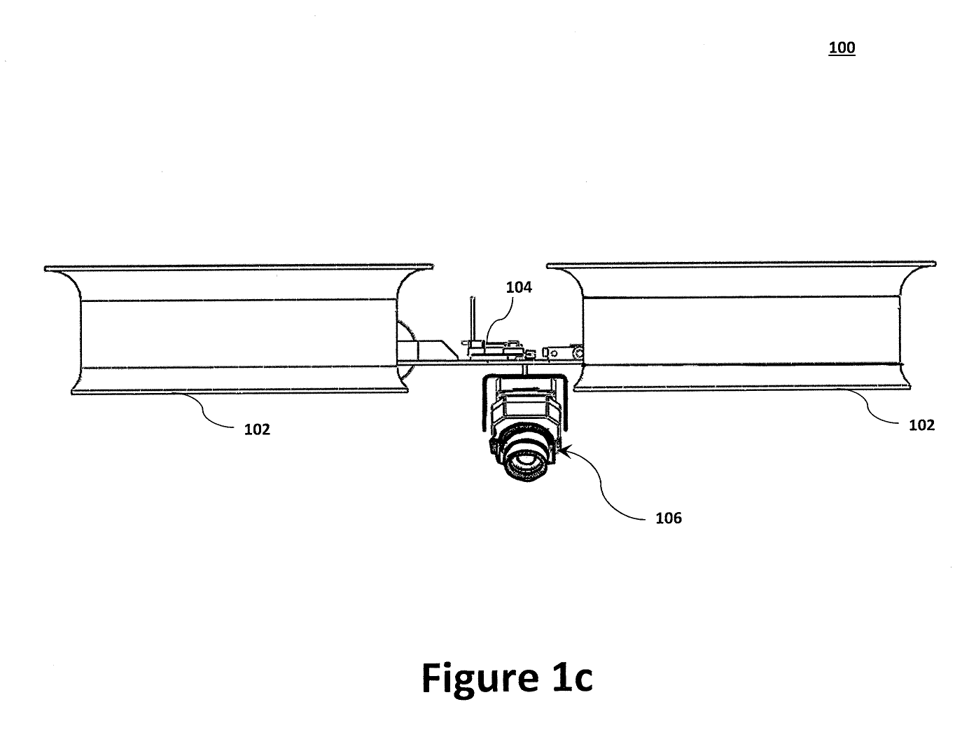

FIGS. 1a through 1c illustrate an example of a primary tethered UAV 100. Specifically, FIG. 1a illustrates the top side of a primary tethered UAV 100, FIG. 1b illustrates the bottom side of the primary tethered UAV 100, and FIG. 1c illustrates a frontal view of the primary tethered UAV 100.

A propulsion system may be coupled to the primary tethered UAV 100 and controlled in a number of ways. For example, propulsion controls may be sent from a ground station (e.g., via a tether or wirelessly). Alternatively, propulsion controls may be sent from an onboard processor 104. The onboard processor 104 may be enabled to receive and process the vehicle's state information (e.g., position, velocity, and/or acceleration in all six degrees of freedom) to output motor controls—a process that is commonly referred to as autopilot. The onboard processor 104 may also be used to control the tether management device, relay data communications, encrypt gathered data, etc.

To provide the thrust necessary for controlled flight, the propulsion system of the primary tethered UAV 100 may be operatively coupled to one or more propellers 102 (e.g., lift fans). The one or more propellers 102 may be independently operated to enable controlled flight. Moreover, the propellers 102 may be shrouded and/or ducted to increase performance and safety. While the propellers 102 are preferably driven by an electric motor, thus reducing weight, noise, and eliminating the need for an onboard fuel tank, other thrusting means are contemplated, including, for example, internal combustion engines.

The primary tethered UAV 100 may further comprise a sensor payload 106 for data collection. The sensor payload 106 may include, for example, a surveillance camera, one or more microphones, thermometers, hygrometers, barometers, anemometers, pyranometers, or any other sensor contemplated by the operator. Any data collected by the primary tethered UAV 100 via the sensor payload 106 may be transmitted in real time to an end user for viewing or to a computer-implemented database where the data may be stored for later use. The end user may be located at, for example, the ground station or remotely where access is provided via a network (e.g., the Internet). The data transmission may be wireless or wired. When a wired communication link is employed, it may be accomplished via conductors embedded in the tether. Any collected data may be further stored to one or more onboard data storage device for retrieval at a later time.

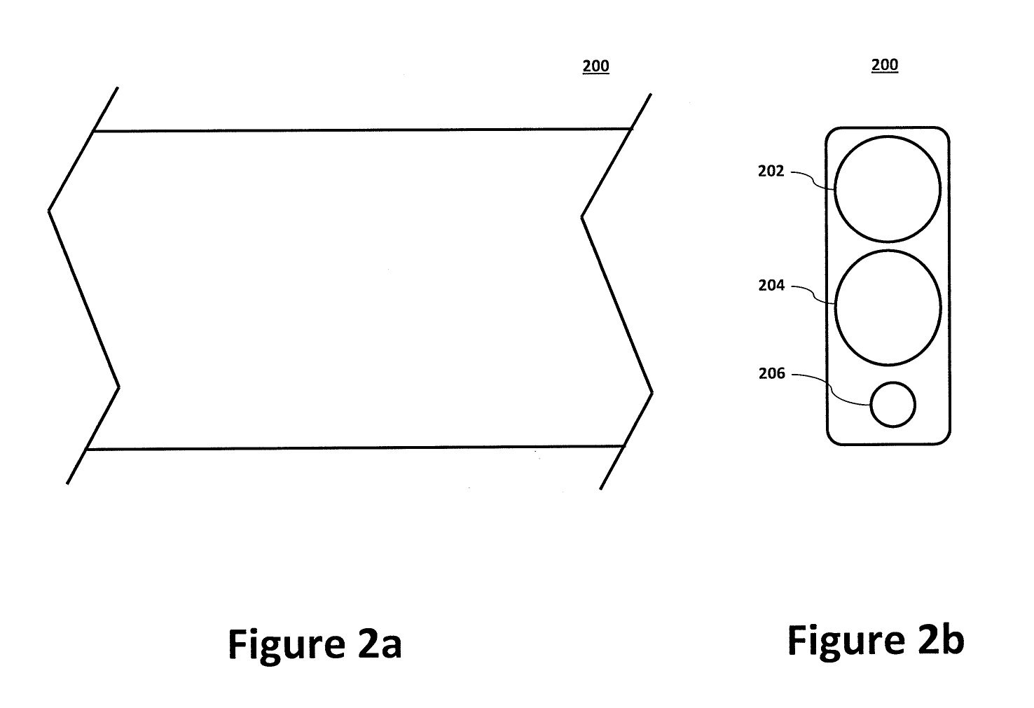

FIGS. 2a and 2b illustrate a tether that may be used for communicating data and/or delivering power. FIG. 2a provides a side-view illustration of the tether, and FIG. 2b provides a cross-sectional view of the tether 200. The tether 200 is preferably strong enough to resist breakage, yet lightweight, thereby reducing the amount of power necessary for flight. The tether 200 can transfer data and power between a tethered UAV and a ground station via one or more conductive cables that either make up the tether 200 or are embedded in the structure of the tether 200. For example, the tether 200 may comprise one or more bundles of conductive cables 204, 206 (e.g., an umbilical) and may further comprise a nylon or metal cable 202 for providing additional strength. If a metal material is used, it would preferably be a lightweight metal or metal alloy.

The one or more bundles of conductive cables 204, 206 may be used for communicating data and/or delivering power. To reduce interference to the data conductors by, for instance, the power-supplying conductors, the one or more bundles of conductive cables 204, 206 may employ known electrical magnetic interference (“EMI”) shielding techniques. The data communications may be transferred over a separate, smaller conductive cable 206, or over the same conductive cable used for power delivery. To reduce the weight of the tether 200, power may be delivered, or transferred, through the tether 200 at high voltage (low current). A higher voltage allows for higher gauge (smaller diameter) conductive cabling and reduces the amount of EMI received by the data communications.

Electric power is preferably delivered as direct current (“DC”), as opposed to alternating current (“AC”); however, it is possible to use AC power delivery. Many components on the UAVs operate by receiving low-voltage power (e.g., 3-12V). To achieve these power levels, multiple methods may be used to reduce the high voltage sent from the ground station to a low voltage required by the UAVs. One method is to rely on the naturally occurring voltage drop across the tether due to the electrical resistivity of the conductive cable (as defined by Ohm's law). Another method is to integrate a power transformer with the UAV for reducing the high voltage to a low voltage required for UAV operation. The same power transformer may or may not be included in the ground station for increasing low voltage to high voltage.

In certain aspects, the tether 200 may deliver only power and not data communications, wherein data communications may be delivered wirelessly from one or more UAVs to the ground station. This configuration would alleviate EMI concerns.

If data need be communicated and power need not be transferred between a tethered UAV and the ground station, it is possible to completely eliminate the conductive cables and to only use, for example, nylon and/or metal cable. For example, a tethered UAV having a sufficient power supply (e.g., battery or solar cell) may rely solely on wireless communication and/or onboard data storage. To increase strength, it is also contemplated that the previously described tethers may employ one or more braiding techniques.

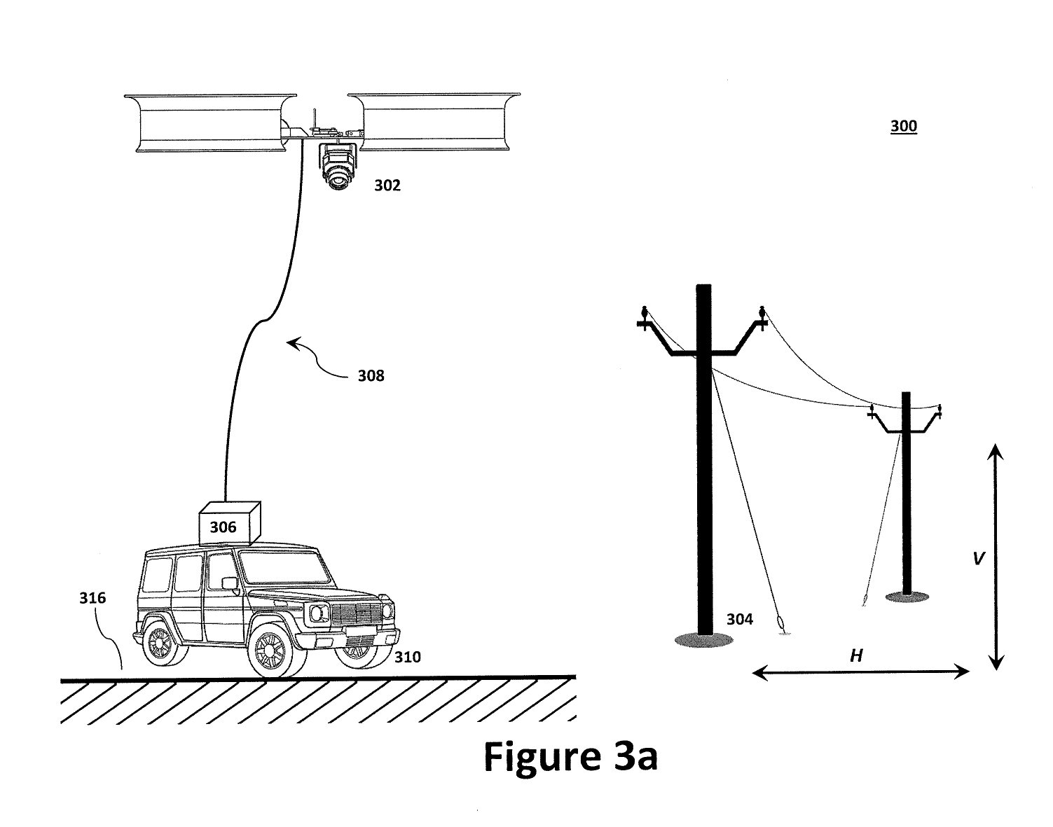

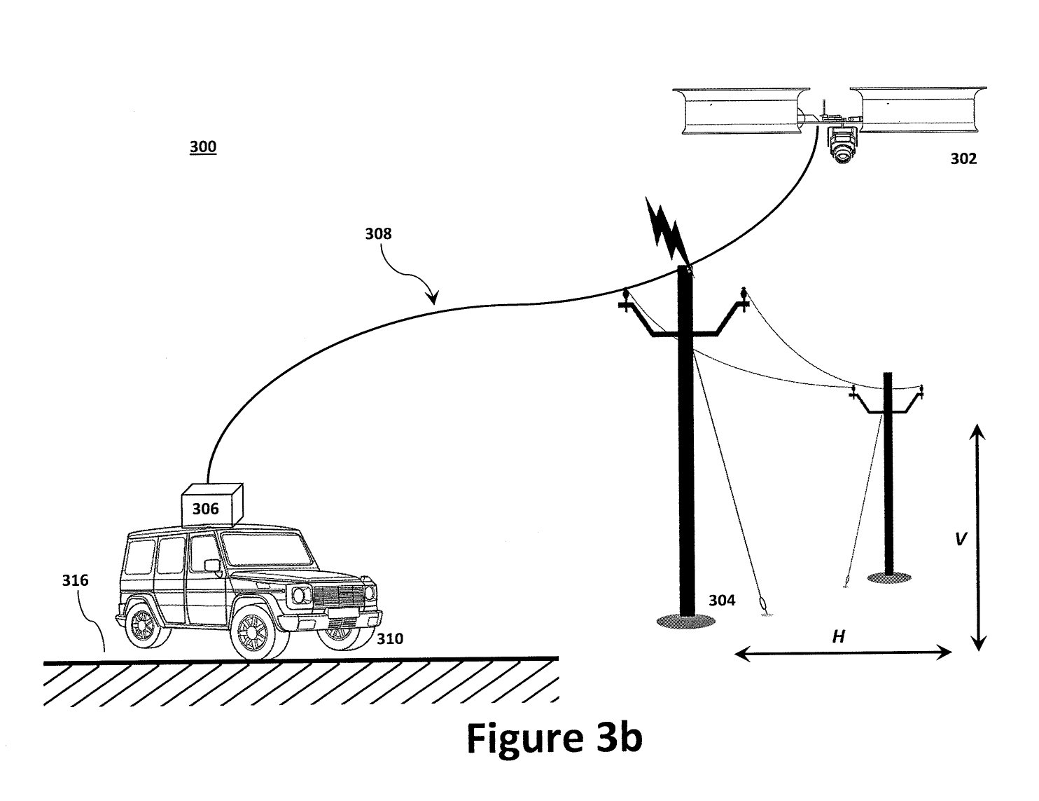

FIGS. 3a and 3b show a system 300 having a single primary tethered UAV 302 coupled to a ground station 306 by way of a tether 308 (e.g., the tether of FIG. 2). As illustrated in FIG. 3a, a first end of the tether 308 may be physically attached to a ground station 306, while a second end may be attached to a primary tethered UAV 302. The ground station 306 preferably comprises a tether management system or other securing means for retaining and controlling the amount of tether released. The tether management system may be, for example, a winch or any other mechanical device that is capable of pulling in, letting out, or otherwise adjusting the tension/length of the tether 308. During operation, the ground station 306 may reside on or be attached to a ground vehicle 310 (e.g., a military truck). Alternatively, the ground station 306 may be secured directly to the ground 316 or to a permanent structure, such as a building. When not in operation, the ground station 306 may be used to provide storage for at least one UAV. For example, the ground station may have incorporated therein a cavity configured to receive one or more UAVs. Once the one or more UAVs have been placed in the cavity, a lid or cover may be provided to close the cavity to protect the UAV from the elements.

As noted with regard to FIG. 2, in addition to securing one or more UAVs to a ground station, the tether 308 may also be used to transfer data and power to primary and/or secondary UAVs. For example, power may be supplied to a UAV by the ground station, which may store the power (e.g., batteries, fuel cell, etc.), generate the power internally (e.g., gas generator, solar collection, etc.), or have the power supplied from an external means. As previously discussed, data and power may be transferred over conductive cables that make up the tether 308 or are embedded in the tether's 308 structure. Thus, data may be sent from the ground station 306 and pass through or around any secondary UAVs (discussed below) and arrive at the primary tethered UAV 302.

Although the arrangement of FIG. 3a is practical when the tethered UAV 302 is traveling substantially vertically (direction V), such an arrangement can be hazardous when the tethered UAV 302 travels horizontally (direction H), especially if there are structures 304 in the vicinity. For example, as illustrated in FIG. 3b, the tether 308 may become entangled with or otherwise establish contact with nearby structures 304, such as a power line. In this situation, the tether 308 may not only become tangled, thereby inhibiting proper operation of the tethered UAV 302, but the tether 308 could cause an electrical short or other damage.

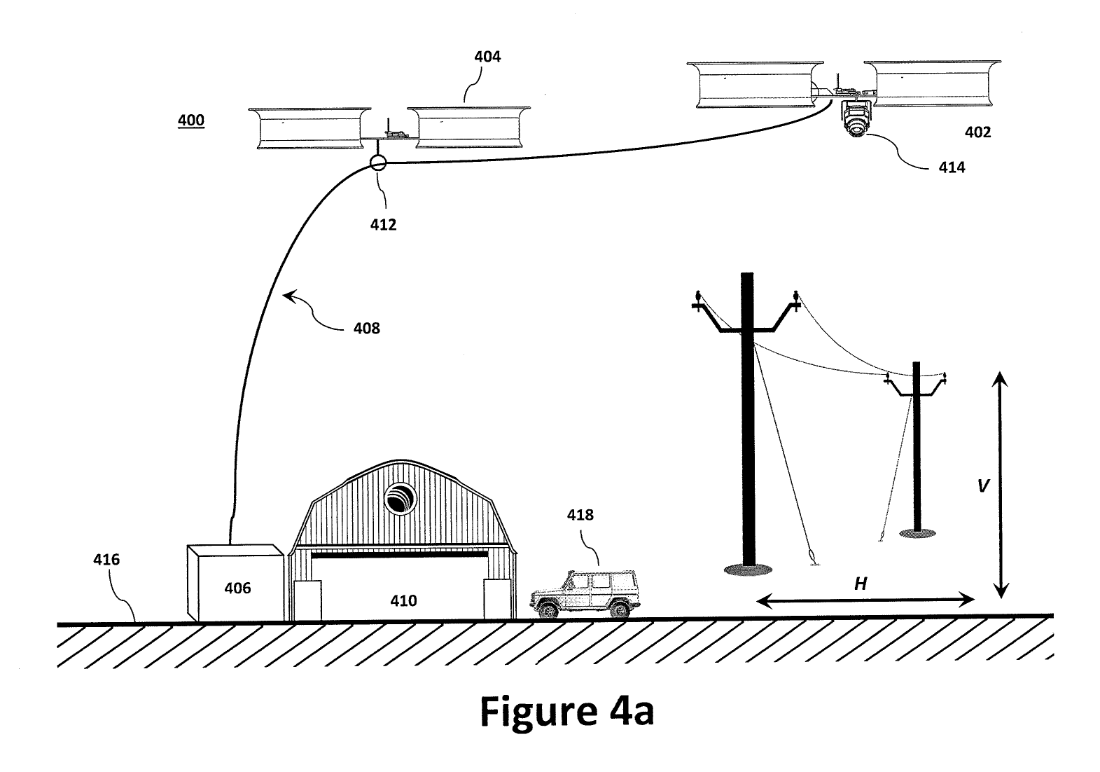

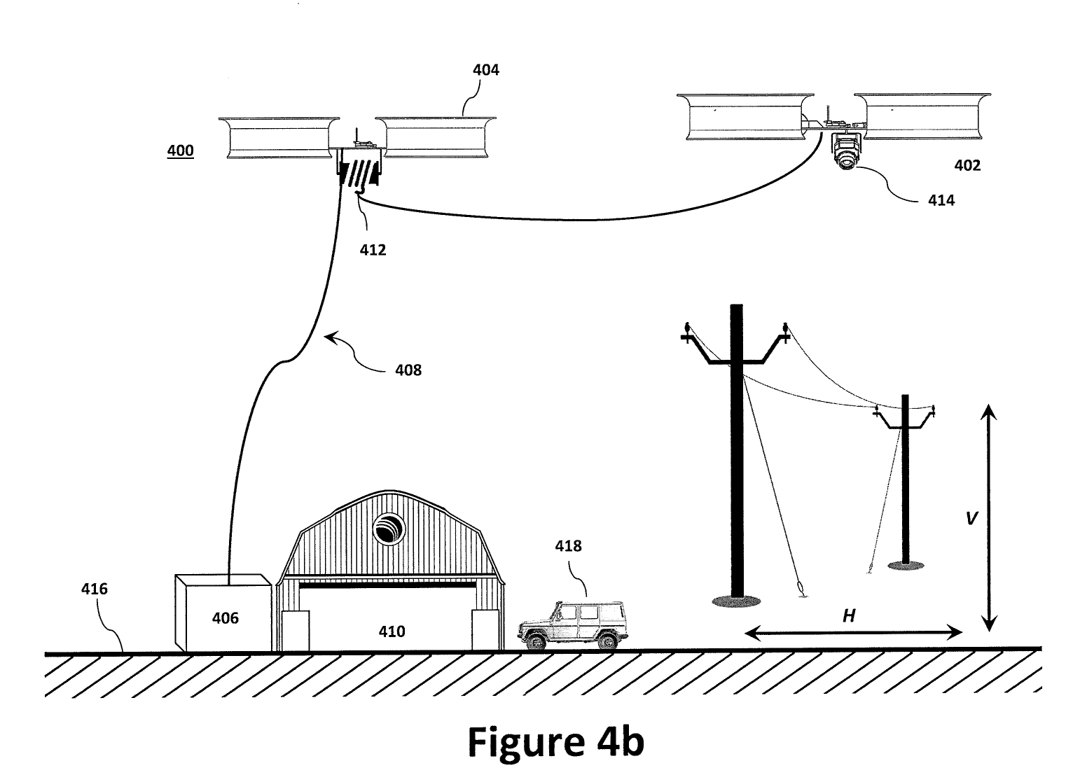

Like the system 300 of FIGS. 3a and 3b, the primary tethered UAV 402 of FIG. 4a is located at the second end of a tether 402 while the first end of the tether 408 is physically attached to a ground station 406. As disclosed herein, the tethered UAV's 402 flight path may be extended by introducing one or more additional UAVs 404, known as secondary UAVs 404, that are tethered together and/or cooperate together to extend the horizontal flight path of the outermost UAV 402. More specifically, FIG. 4 illustrates a system 400 according to a second aspect in which a primary tethered UAV 402 and a secondary UAV 404 are tethered in series to the ground station 406. The ground station 406 is depicted as being positioned directly on the ground 416; however, the ground station 406 may be coupled to, or integrated with, a permanent structure, such as a building 410. Alternatively, the ground station 406 may be couple to, or integrated with, a vehicle 418, as illustrated in FIGS. 3a and 3b.

The secondary UAV 404 may be positioned along the tether 408 at a point between the ground station 406 and the primary tethered UAV 402. As illustrated in the figures, a function of the secondary UAV's 404 is to manage the tether 408, thereby allowing the primary tethered UAV 402 to extend its horizontal flight area (direction H) without permitting the tether 408 to become entangled with nearby structures. Specifically, the secondary UAV 404, which is located between the ground station 406 and the outermost UAV 402, provides support for the tether 408—serving a function analogous to a telephone pole supporting its cabling. In essence, the secondary UAV 404 provides positioning control of the tether, thereby increasing mobility of the primary tethered UAV.

The secondary UAV 404 comprises at least a propulsion system and a tether management device 412. A tether management device 412 may be as straightforward as a structural hoop that the tether 406 passes through. Alternatively, as illustrated in FIG. 4b, the tether management device 412 may also be configured to store a given length of tether 408 on a reel and to control the amount of tether 408 released between the secondary and primary tethered UAVs. Like the primary tethered UAV 100 of FIGS. 1a and 1b, the primary tethered UAV 402 comprises a propulsion system as well as a surveillance payload of data gathering. Accordingly, a function of the primary tethered UAV 402 is to gather data, which may be accomplished through the previously described surveillance sensor payload 414.

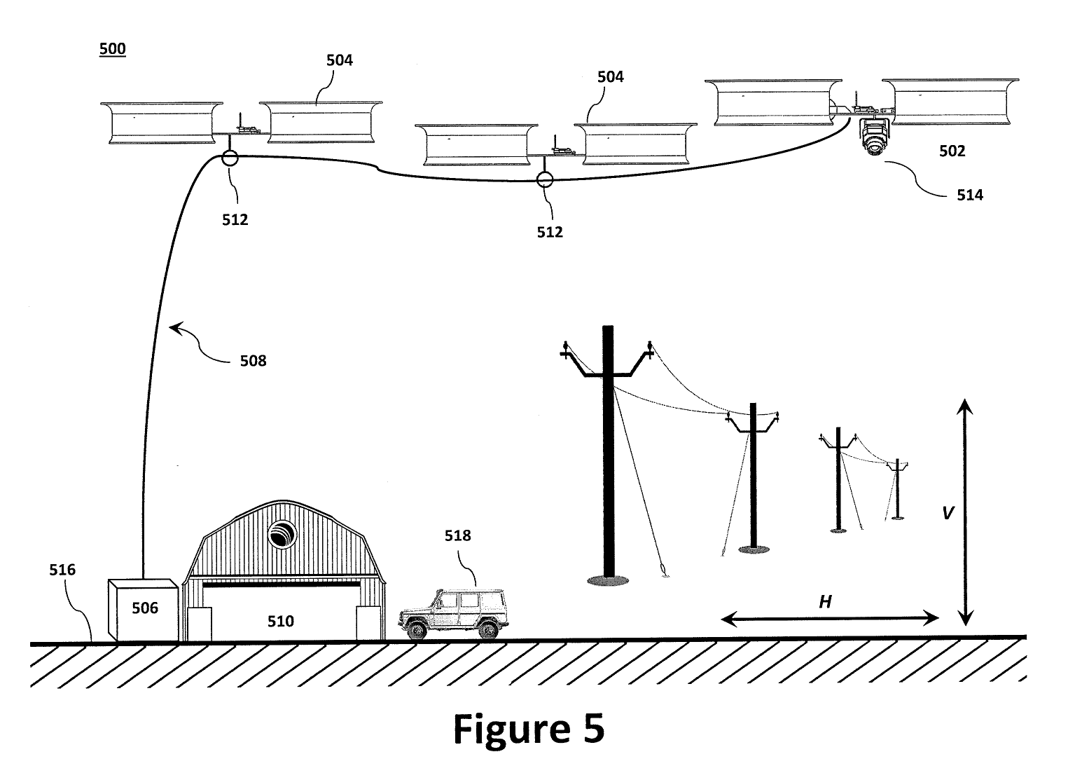

FIG. 5 illustrates a second system 500 wherein multiple secondary UAVs 504 are employed. The system 500 of FIG. 5 is substantially the same as the system 400 of FIG. 4, wherein the primary tethered UAV 502 is located at the second end of the tether 508 while the first end of the tether 508 is physically attached to a ground station 506. The tethered UAV's 502 flight path, however, may be further extended by introducing a second secondary UAV 504 that is tethered together and/or cooperates with the first secondary UAV 504 to extend the horizontal flight path of the outermost UAV 502. Accordingly, FIG. 5 illustrates a system 500 according to a third aspect wherein a primary tethered UAV 502 and two secondary UAVs 504 are tethered in series to the ground station 506. As in FIG. 4, the ground station 506 is depicted as being positioned directly on the ground 516; however, the ground station 506 may be coupled to, or integrated with, a permanent structure, such as a building 510. Alternatively, the ground station 506 may be coupled to, or integrated with, a vehicle 518, as illustrated in FIGS. 3a and 3b.

The second secondary UAV 504 may be positioned along the tether 408 at a point between the ground station 406 and the first secondary UAV 504. As illustrated in the figure, a function of the two secondary UAVs 504 is to manage the tether 508, thereby allowing the primary tethered UAV 502 to further extend its horizontal flight area (direction H) without permitting the tether 508 to become entangled with nearby structures. As discussed in relation to FIG. 4, the secondary UAVs 504 each comprise at least a propulsion system and a tether management device 512, which may be a structural hoop or a device that controls the amount of tether 508 released between the two secondary and primary tethered UAVs.

Although the systems of FIGS. 4 and 5 respectively teach the use of one and two secondary UAVs 404, 504, the number of secondary UAVs may be increased as desired for a particular application. For example, if the horizontal flight area must be further increased, the system may employ three or more secondary UAVs. In fact, the system may employ a virtually unlimited quantity of secondary UAVs.

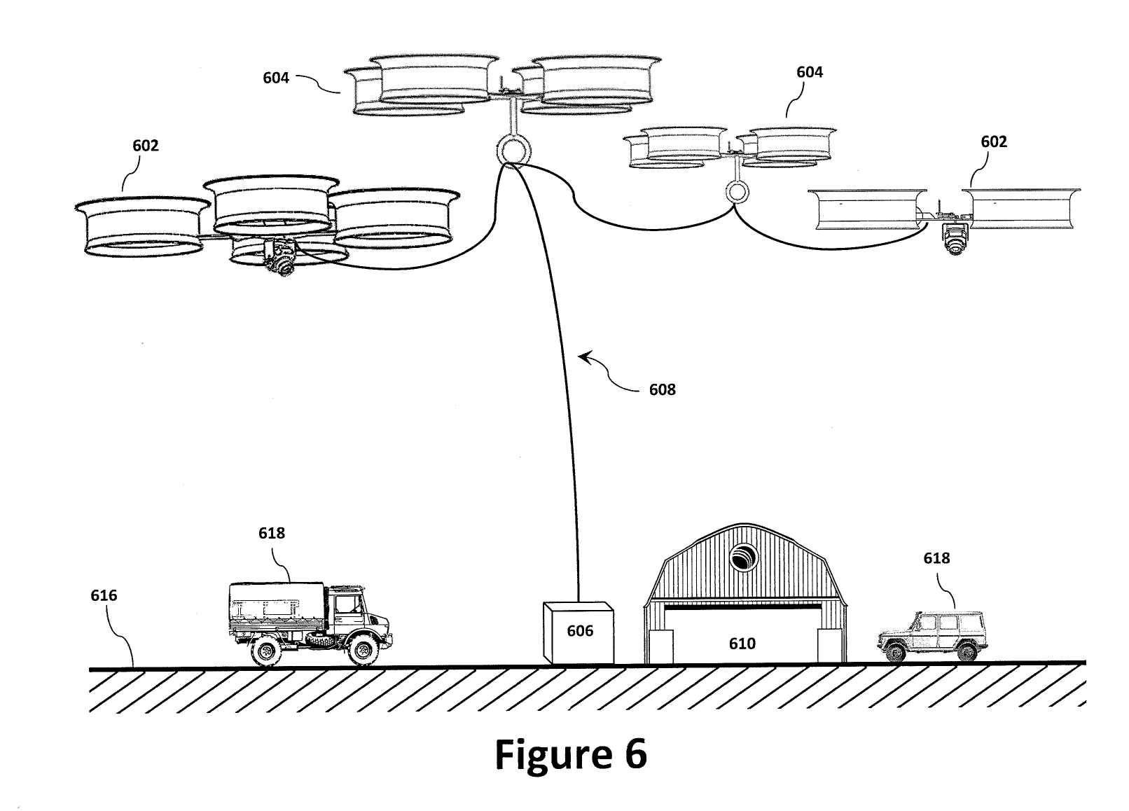

FIG. 6 illustrates a system 600 having two primary tethered UAVs 602 and two secondary UAVs 604. The system 600 of FIG. 6 is substantially the same as the systems 400, 500 of FIGS. 4 and 5, wherein the primary tethered UAVs 602 are located at the second and third ends of the tether 608, which has been split to form a Y-shape, while the first end of the tether 608 is physically attached to a ground station 606. As illustrated, two secondary UAVs 604 are positioned on the tether 608 to permit horizontal movement of the two primary tethered UAVs 602. As with the previous examples, each of the two primary tethered UAVs 602 and two secondary UAVs 604 may be independently controlled to cover a desired area.

Because one objective of these systems is to protect nearby people and objects from the dangerously high voltage levels that may be carried by the tether, the previously described systems may further employ systems and methods for recognizing a severance (i.e., break) of the tether and subsequently implement one or more safety procedures that address the concern of an exposed high voltage line and/or falling aerial vehicle. For example, if the tether is supplying power to one or more UAVs, a severed tether may result in an immediate cutoff of voltage across all tethers.

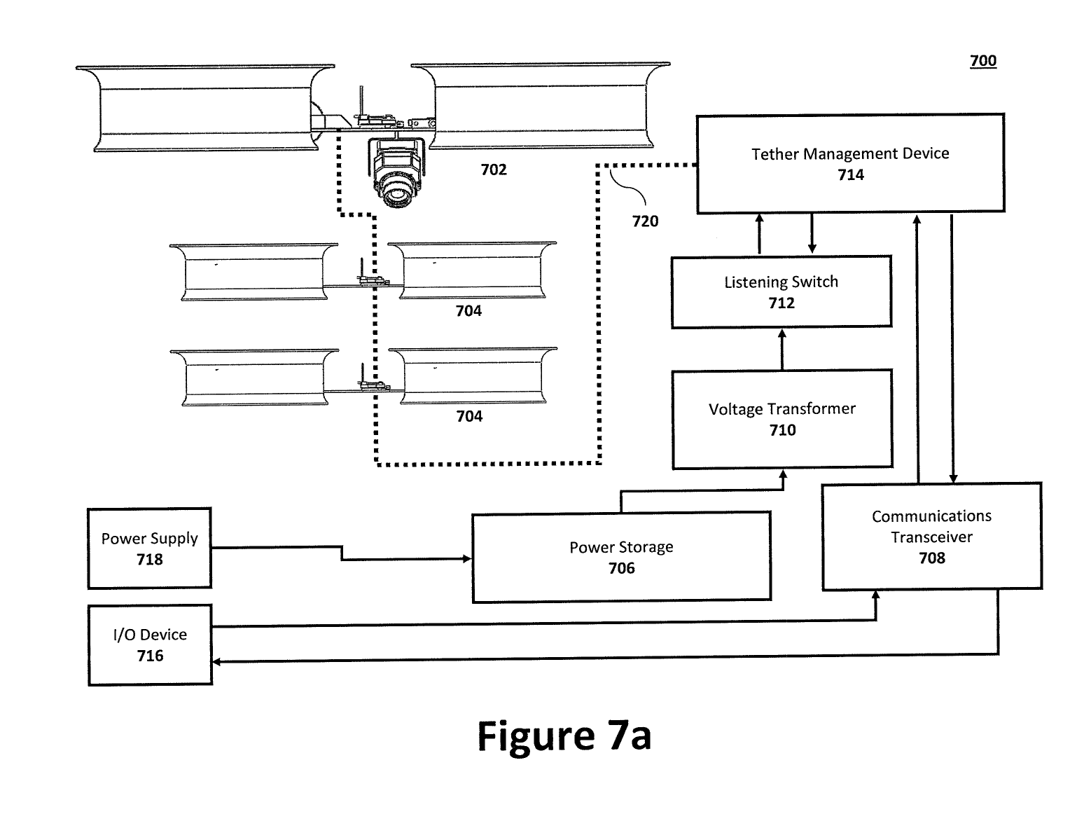

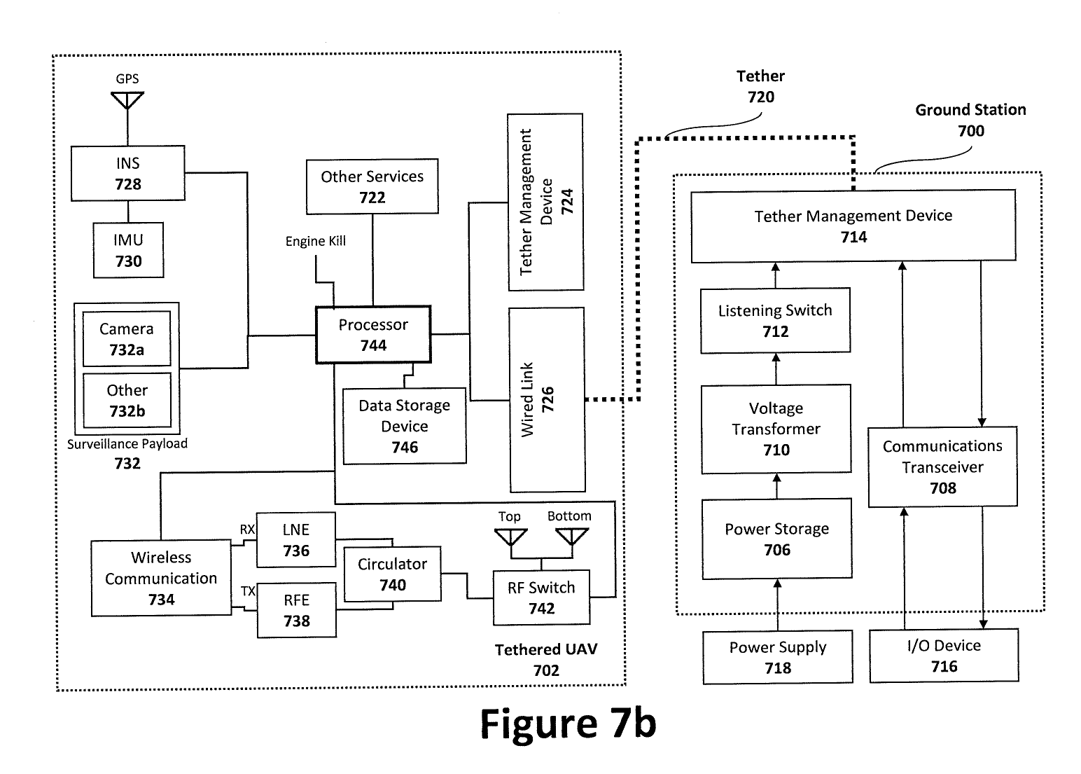

FIG. 7a illustrates a block diagram of a ground station 700 equipped with a voltage cutoff device for use with the previously discussed tethered UAV systems. As illustrated, the ground station 700 may comprise a power storage device 706 (e.g., a battery), voltage transformer 710, a listening switch 712, a communication transceiver 708, and a tether management device 714. The ground station 700 may be operatively coupled to one or more primary and secondary tethered UAVs 702, 704 via the tether 720. The ground station 700 may be further coupled with an external power supply 718.

The ground station's 700 communication transceiver 708 may be used to transmit data signal from an end user, which may be communicated via the input/output device 716, to the primary and secondary tethered UAVs 702, 704 by way of the tether 720 and tether management device 714. Data collected by the primary tethered UAV 702 (or any other UAV along the tether 720) may be transmitted in real time to the end user for live viewing, or to an apparatus (e.g., a computer) where it may be stored and/or displayed. Similarly, flight control data (i.e., flight commands from the end user or a flight computer) may be communicated between the ground station 700 and the primary and secondary tethered UAVs 702, 704, using the same tether 720. Alternatively, the ground station 700 and the primary and secondary tethered UAVs 702, 704 may employ wireless communication devices.

As illustrated, the power storage device 706 may be electronically coupled to an outside power supply 718. The outside power supply 718 may include, for example, a generator, line current (e.g., from a power grid), solar cells, etc. Power stored in the power storage device 706 may be transformed via a voltage transformer 710 to output predetermined voltage and current levels (e.g., the power supply's 718 power may be converted to a high voltage). The output power is transported to the tether management device 714 for delivery to the primary and secondary tethered UAVs 702, 704 by way of a listening switch 712 and tether management device. Until the listening switch has been triggered, the tether management device 714 supplies power to the primary and secondary tethered UAVs 702, 704 via the tether 720. When the listening switch 710 is triggered (e.g., resulting from damage or a break in the tether 720, discussed below), an electric switch may be opened, thus breaking the circuit, and the tether management device 714 shall discontinue supplying power to the primary and secondary tethered UAVs 702, 704. Once the power supply has been discontinued, the primary and secondary tethered UAVs 702, 704 enter a safe-fall mode.

More specifically, tether severance (or any other action resulting in a loss of power) may result in a “safe-fall” mode for all UAVs 702, 704. In safe-fall mode, falling UAVs may be passively or actively controlled such that land impact is reduced and is thereby relatively safe and of little harm to the people or objects below. These safety measures recognize that in order to realize the benefits of a tethered aerial vehicle, the aerial vehicles should terminate sustain flight upon tether severance. As such, the tethered aerial vehicles may not have any onboard power generation or supply that could power flight after loss of power through the tether.

Accordingly, the ground station 700 may include one or more cable diagnostic devices for determining the operating condition of the tether 720 and whether a severance occurs in the tether. For example, the listening switch 712 located at the ground station 700 can detect a compromise of the tether's condition or whether a UAV 702, 704 is connected to the tether 720. Thus, the ground station 700 will not apply power through the tether 720 to the UAV 702, 704 unless a UAV connection is detected.

The listening switch 712 may operate in a number of ways and may transmit an electrical signal through the tether to detect damage or a serverage. A first method is AC detection. AC detection methodology involves transmitting a low frequency AC signal and listening for the same signal to be received back. If the tether 720 is compromised (e.g., damaged), the AC signal will also be compromised. If the tether is severed, the AC signal will be nonexistent. A second method is DC detection, which applies a DC current and detects the presence of a UAV by measuring the electrical load applied by the UAV. Like the AC equivalent, if the condition of the tether is compromised, the detected load on the tether is accordingly compromised. Similarly, if the tether is severed, no load is detected.

In certain aspects, the same listening switches could reside on the one or more of the UAVs 702, 704. When a severance in the tether 720 is detected, the ground station immediately stops transmitting power through the tether 720. If the tether condition is deemed unacceptable but still intact (e.g., not severed), the ground station 700 can either stop transmitting power or prompt all UAVs to be grounded at the ground station 700.

FIG. 7b provides a block diagram for a tethered UAV 702 coupled with a ground station 700 via a tether 720. While the detailed block diagram for the UAV in FIG. 7b is directed to the primary UAV 702, the secondary UAV 704 would have substantially the same components, with the possible exception of the surveillance payload 732. However, one of skill in the art would not be prohibited and should not be discouraged from including surveillance payload 732 in a secondary UAV 704 if the need arises.

The tether 720 can communicate data and/or transfer power between the ground station 700 and on or more tethered UAVs 702, 704. Each tethered UAV 702 typically includes an onboard processor 744 that controls the various aircraft components and functions. The processor 744 may be communicatively coupled with a wired link 726, an Inertial Navigation System (“INS”) 728 (e.g., Vector Nav VN-100) that is communicatively coupled with an inertial measurement unit 730 and GPS receiver, an onboard data storage device 746 (e.g., hard drive, flash memory, or the like), a tether management device 724, a surveillance payload 732, a wireless communication device 734, or virtually any other desired services 722.

Data and/or power may be received at the tethered UAV 702 via the wired link 726. The wired link 726, which is operatively coupled to a the vehicular computer 744, may be configured to couple with one or more tethers 720. For example, the wired link 726 may be configured to receive data via a first tether portion and to communicate, or relay, said data to a ground station 700 or another UAV (or other similar device) via a second tether portion. The wired link 726 may also be configured to receive power from the ground station 700 (or another UAV) and to deliver power to another UAV.

Accordingly, one or more intermediate secondary UAVs 704 may reside along the tether 720 between UAV 702 and ground station 700. To facilitate tether 720 replacement and simplify maintenance, the tether 720, or each tether portion (e.g., the spans of tether between nodes—UAVs and/or ground stations), may be removably coupled to the wired link 726.

The tether management device 724 may be operatively coupled to the processor 744. The tether management device 724 may be, for example, a winch or any other mechanical device that is capable of pulling in, letting out, or otherwise adjusting the tension/length of the tether 720. In fact, the UAV 702 may be configured with a tether adjusting device 724 for each tether portion coupled to the UAV 702. Incorporating a tether management device 724 with each UAV allows for dynamic adjustment of the tether portions between nodes.

To facilitate optional wireless communication, the UAV 702 may further comprise an air communication link 734 enabled to transmit (“TX”) and receive (“RX”) data using one or more antennas (e.g., top and bottom) via a circulator 740, LNE 736 and RFE 738. The antenna may be controlled via the processor 744 that is operatively couple to an RF switch.

To collect data and monitor an area, the UAV 702 may be equipped with a traditional ISR surveillance payload 732. For example, the UAV 702 may be equipped with one or more cameras 732a, audio devices, and another sensor 732b. Any video, or other data, collected by the UAV 702 may be communicated to the ground control station 700 in real time wirelessly or via the tether 720. The UAV 702 may be further equipped to store said video and data to the onboard data storage device 746.

If the UAV 702 is operated in an unfriendly zone, it may be advantageous to implement a data self-destruction protocol. The UAV 702 may be programmed to erase, or otherwise destroy, the onboard data storage device 746 if the UAV 702 determines that it may have fallen into an enemy's possession. For example, the UAV 702 onboard data storage device 746 may be erased automatically when a severed tether is detected or upon touching down in a location outside of a predefined radius from the launch area, based on GPS calculations, or, if a crash is detected, e.g., based on a sudden impact.

While the ground station 700 of FIG. 7b does not show any wireless communication element, it is contemplated that one or more wireless communication devices may be employed, such as a wireless communication link. The wireless communication link may communicate with the UAV 702 using a radio interface module and one or more antenna pointing systems. The ground control station may communicate with the UAV, using L band or another spectrum reserved for military use. L band refers to four different bands of the electromagnetic spectrum: 40 to 60 GHz (NATO), 1 to 2 GHz (IEEE), 1565 nm to 1625 nm (optical), and around 3.5 micrometers (infrared astronomy). In the United States and overseas territories, the L band is generally held by the military for telemetry.

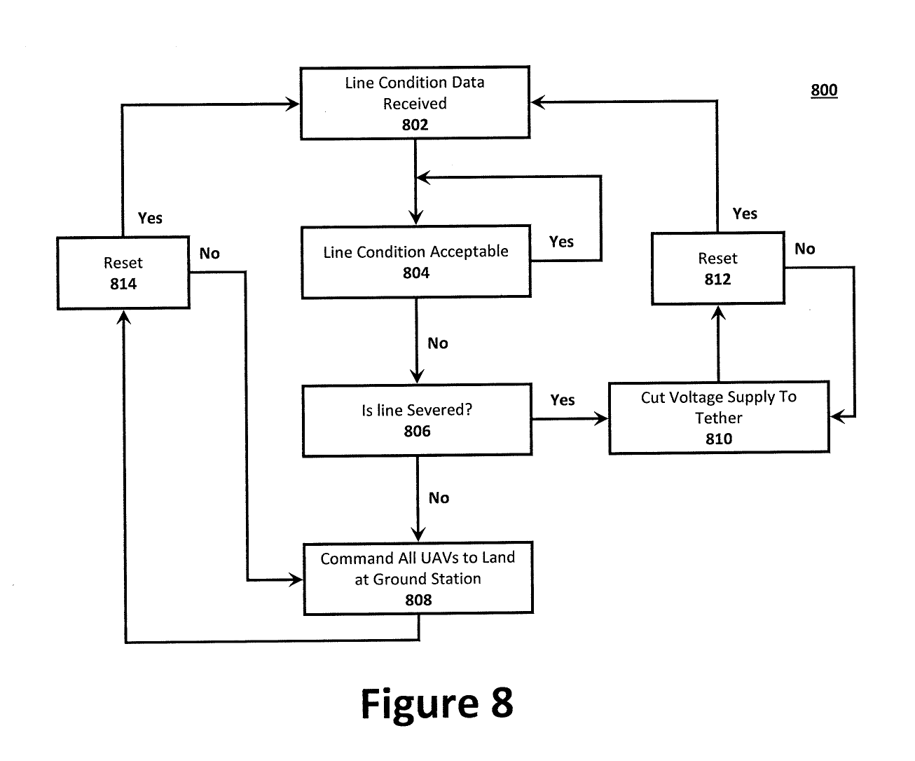

Turning now to FIG. 8, a flow diagram of a listening switch protocol 800 is provided. During UAV flight, at step 802, the listening switch may dynamically monitor the tether condition by analyzing received signals and measurements (e.g., using AC/DC detection methodology). If the line condition is found to be acceptable at step 804, the UAV continues its normal flight plan. If the line condition is found to be unacceptable at step 804, the listening switch will determine whether the line has been severed at step 806. If the line has been severed at step 806, the power supply to the tether is terminated at step 810 and all UAVs in communication with the tether will enter safe-fall mode. If the line has not been severed at step 806, but is still unacceptable (as determined at step 804), all UAVs in communication with the tether may be instructed to return to the ground station for landing. In some aspects, it may be desirable to further include reset switches 812, 814—for instances in which the power supply may have been inadvertently cut at step 810 or the UAVs were mistakenly commanded to return to the ground station at step 808. In such a case, the triggering of a reset switch 812, 814 will cause the protocol to return to step 802 where the tether will be reevaluated for damage.

For example, the listening switch protocol may transmit a low frequency signal from a ground station through a tether and back to the ground station via the same tether. The listening switch may then listen for a received low frequency signal at the ground station. If no signal is detected at the ground station, the received low frequency signal may be set to zero or null. The listening switch may then compare the received low frequency to the transmitted low frequency signal to calculate a signal loss value. A predetermined signal loss threshold may be used to indicate whether the tether has been compromised. The predetermined signal loss threshold may take a number of factors into account, including, for example, signal loss through resistance, weather interference, etc. The predetermined signal loss threshold value may be stored to data storage device and recalled by the listening switch.

The listening switch may trigger the ground station to stop transmitting power through the tether when the received low frequency signal is zero or null. Alternatively, the listening switch may instruct each aerial vehicle coupled to the tether to return to the ground station when the signal loss value has exceeded the stored signal loss threshold value. In another alternative, the listening switch may authorize each aerial vehicle coupled to the tether to continue its current flight plan when the signal loss value has not exceeded a signal loss threshold value. The current flight plan may be a stored flight plan or simple mean that the aerial vehicle may continue normal operation.

As noted, each tethered UAV may be configured to enter a safe-fall mode when power is lost (e.g., when the ground station stops transmitting power through the tether). A safe-fall mode may enable the UAVs to fall to the ground safely without requiring an on-board power supply. To achieve safe-fall mode, the tethered UAV may employ one or more safe-fall features and/or devices, including, for example, descent stabilization devices for controlling the altitude of the UAV during the fall, and a device for reducing peak force during ground impact. The UAV altitude during descent may be controlled using one or more descent stabilization devices (e.g., a deployed parachute, stabilizing fins, reaction wheel, etc.). Similarly, the device for reducing peak force during ground impact may incorporate an impact attenuator (e.g., foam structure, air bag, gas spring, etc.).

An example of a safe-fall UAV 900 is illustrated in FIGS. 9a and 9b. Specifically, FIG. 9a illustrates the top side of a safe-fall UAV 900, while FIG. 9b illustrates the bottom side of the safe-fall UAV 900. The hardware and propulsion systems of the safe-fall UAV 900 are substantially the same as the primary and secondary tethered UAVs of the previously described systems. Indeed, safe-fall features may be integrated with virtually any existing UAV, including the primary or secondary tethered UAVs.

The safe-fall UAV 900 may comprise one or more propellers 902, an on-board processor 904 and, in some cases, an optional sensor payload (not shown). However, the safe-fall UAV 900 may further comprise safe-fall features, such as impact attenuators 906 for reducing peak force during ground impact. The impact attenuators 906, which may be positioned on the under side of each fan 902, can be constructed using, for example, foam structures, air bags, gas springs, etc.

In certain aspects, the safe-fall UAV 900 may be actively controlled. For example, the safe-fall UAV 900 may comprise flight control surfaces that may be actuated by power generated by the propulsion system auto-rotating during the fall. Alternatively, the safe-fall UAV 900 could comprise an onboard power storage device for providing power to the control surfaces. The onboard power storage device is preferably lightweight and, because it will only need to supply power for a limited time (e.g., during descent), the onboard power storage device need not be too large.

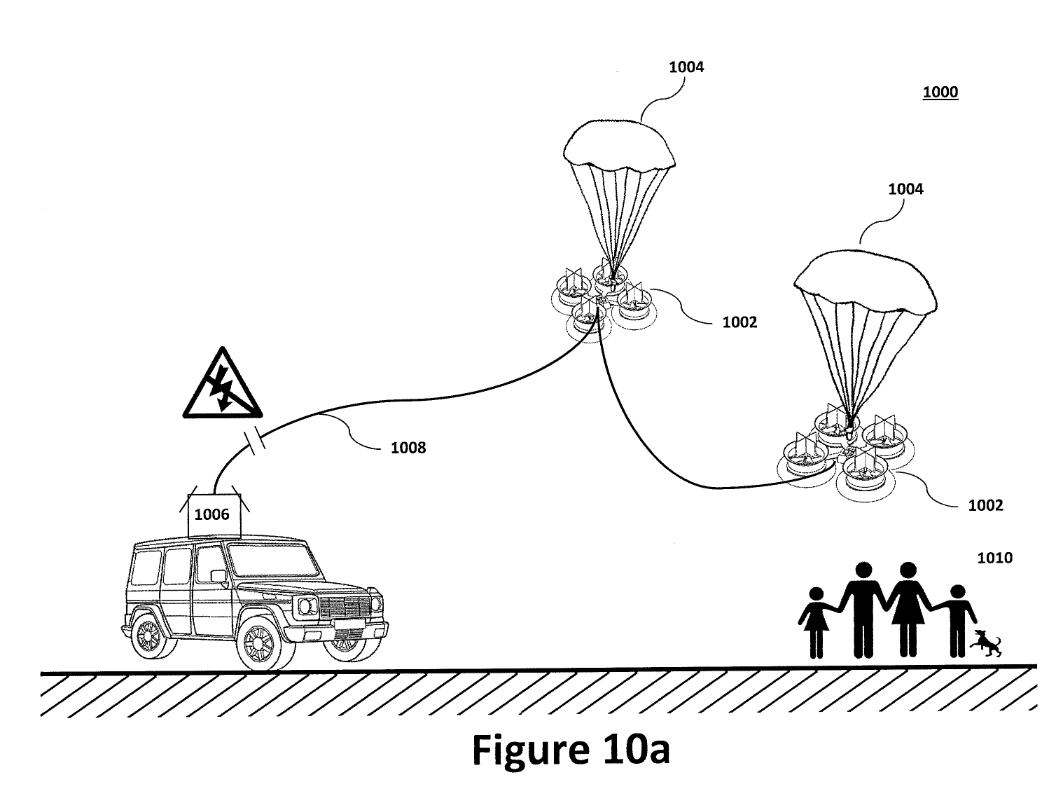

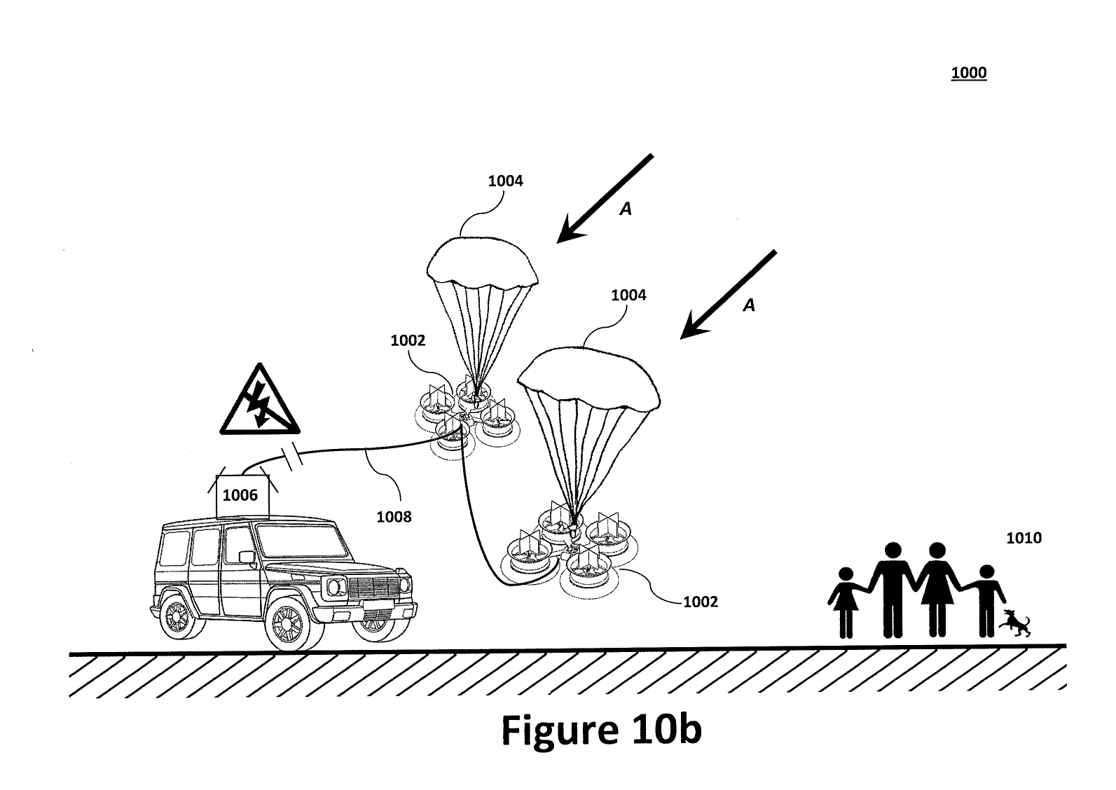

FIG. 10a illustrates an system 1000 wherein the power supply to the tether 1008 has been terminated by the ground station 1006 (e.g., via the tether management device and listening switch). In response to the termination of the power supply, the tethered UAVs 1002 have entered safe-fall mode. The descent stabilization device of the tethered UAVs is depicted as a parachute 1004; however, other descent stabilization devices may be used (e.g., stabilizing fins, reaction wheel, etc.). As illustrated in FIG. 10b, when active control of the vehicle during descent is enabled, the UAVs 1002 may be guided or otherwise steered in direction A to land near the ground station 1006, thus minimizing damage to people or objects 1010 below.

Although the present invention has been described with respect to what are currently considered to be the preferred embodiments, the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

All U.S. and foreign patent documents, all articles, all brochures, and all other published documents discussed above are hereby incorporated by reference into the Detailed Description of the Preferred Embodiment.

What is claimed is:

1. An aerial vehicle system for gathering data, the aerial vehicle system comprising:
a ground station;
a first aerial vehicle, wherein the first aerial vehicle comprises a sensor payload;
a second aerial vehicle;
a first tether portion operatively coupled between the ground station and the second aerial vehicle; and
a second tether portion operatively coupled between the second aerial vehicle and the first aerial vehicle;
wherein the first tether portion is configured to deliver power from the ground station to the second aerial vehicle and the second tether portion is configured to deliver power to the first aerial vehicle.

2. The aerial vehicle system of claim 1, wherein the ground station comprises a device for adjusting the tension or length of the first tether portion.

3. The aerial vehicle system of claim 1, wherein the first or second aerial vehicle comprises a device for adjusting the tension or length of the first or second tether portion.

4. The aerial vehicle system of claim 1, wherein the ground station is coupled with a mobile platform.

5. The aerial vehicle system of claim 1, wherein the ground station is coupled with a stationary platform.

6. The aerial vehicle system of claim 1, wherein the ground station is configured to deliver power from a power source to the first aerial vehicle or the second aerial vehicle.

7. The aerial vehicle system of claim 1, wherein the ground station comprises a listening switch configured to determine a condition of the first or second tether portions.

8. The aerial vehicle system of claim 7, wherein the listening switch causes the supply of power to the first or second tether portions to be terminated when tether damage or a tether severance is detected.

9. The aerial vehicle system of claim 1, wherein the first tether portion and the second tether portion are further configured to communicate data.

10. A safety system for use with a tethered aerial vehicle, the safety system comprising:
a ground station, wherein the ground station is configured to deliver power from a power source;
a tether for coupling the aerial vehicle with the ground station, wherein the tether is configured to transmit power from the ground station to the aerial vehicle;
a device positioned between the ground station and the aerial vehicle for adjusting the tension or length of the tether; and
a listening switch, the listening switch being coupled with the ground station and positioned between the power source and the tether;
wherein supply of power from the power source to the tether is terminated when the listening switch detects tether damage or tether severance.

11. The safety system of claim 10, wherein the ground station is coupled with a mobile platform.

12. The safety system of claim 10, wherein the ground station is coupled with a stationary platform.

13. The safety system of claim 10, wherein the tether is further configured to communicate data.

14. A safety method for use with a tethered aerial vehicle, the safety method comprising the steps of:
transmitting an electrical signal from a ground station to an aerial vehicle through a tether and back to the ground station via the same tether;
listening for the electrical signal to be received back at the ground station;
wherein the electrical signal received at the ground station is utilized as a received signal value;
wherein the received signal value to set to zero or null when the electrical signal is not received at the ground station;
comparing the received signal value to the transmitted electrical signal to determine a signal loss value;
triggering the ground station to stop transmitting power through the tether when the received signal value is zero or null;
instructing each aerial vehicle coupled to the tether to return to the ground station when the signal loss value has exceeded a predetermined signal loss threshold value; and
authorizing each aerial vehicle coupled to the tether to continue its current flight plan when the signal loss value has not exceeded the predetermined signal loss threshold value.

15. The safety method of claim 14, wherein each aerial vehicle coupled to the tether enters safe-fall mode when the ground station stops transmitting power through the tether.

16. An unmanned tethered aerial vehicle for increasing safety during descent, the unmanned tethered aerial vehicle comprising:
a tether, wherein the tether is configured to couple with a ground station that is configured to supply power to the aerial vehicle;
one or more propellers;
a descent stabilization device for controlling the altitude of the aerial vehicle during descent; and
a force-impact attenuator for reducing peak force during ground impact when power through the tether is no longer available.

17. The unmanned tethered aerial vehicle of claim 16, wherein the tether is further configured to communicate data.

18. The unmanned tethered aerial vehicle of claim 16, wherein the force-impact attenuator is positioned on a leading porting of the aerial vehicle during descent such that the force attenuator is a first portion of the aerial vehicle to strike the ground first and attenuate the force of impact.

19. The unmanned tethered aerial vehicle of claim 16, wherein the descent stabilization device comprises at least one of: (i) a parachute; (ii) stabilizing fins; or (iii) reaction wheel.

20. The unmanned tethered aerial vehicle of claim 16, further comprising flight control surfaces configured to steer the unmanned tethered aerial vehicle during descent.

21. The unmanned tethered aerial vehicle of claim 20, wherein the flight control surfaces are actuated by power generated by the propulsion system auto-rotating during descent.
